(19) United States
(12) Patent Application Publication
(10) Pub. No.: US 2012/0168239 A1
(43) Pub. Date: Jul. 5, 2012

(54) SELF-CONTAINED DRIVE SYSTEM

(76) Inventors: Florian Gardes, L'isle D'espagnac (FR); Antoine Juan, Champniers (FR); Jerome Penigaud, Bordeaux (FR)

(21) Appl. No.: 13/380,668

(22) PCT Filed: Jun. 22, 2009
(86) PCT No.: PCT/IB2010/052832

§ 371 Date: Mar. 12, 2012

(30) Foreign Application Priority Data
Jun. 24, 2009 (EP) 09290486.1

(51) Int. Cl. B60K 7/00

(52) U.S. Cl. 180/65.51; 301/6.5

(57) ABSTRACT

The invention relates to a self-contained drive system (1) for a vehicle wheel, including a casing (2), accumulators (3) which store and release the energy needed for the self-contained operation of the system, at least one electric motor (4) capable of generating a rotational movement, a controller (5) which manages the control of the electric motor (4) and of the accumulators (3), and a rotational shaft (6) for the self-contained drive system (1). The system is characterized in that the housing (2) directly supports and stands together the accumulators (3), the electric motor(s) (4) and the controller (5), and the system does not include any metal wear parts in (the) mechanical transmission(s) of the rotational movement.

The invention relates to a self-contained drive system adapted to be used in a vehicle wheel.

Typically, a light vehicle may be equipped with an electric drive system making it possible to move the vehicle without effort, or with limited effort by a user. Drive systems are known from the manufacturers of electrically driven trucks, electric bicycles, and electric or hybrid light cars.

Such a system comprises one or more electric motors, a controller that manages the control of the electric motors, a battery made up of accumulators constituting an electric energy reserve, and a controller serving as the interface with the user and making it possible to act on the motor.

Document WO-A-2004/050385 describes a wheel comprising a motor, accumulators, and a controller grouped together in a same assembly. However, the assembly remains complex, as the elements are mounted on an internal support. The wheel is rotated by a pinion between the output shaft of the motor and the rim on which the tire is fastened. Such a transmission system is not secured, as the pinion risks undergoing gripping in case of impact suffered by the wheel.

Document WO-A-03/030336 describes a drive system comprising a motor, accumulators, and a controller in a single assembly. The accumulators and the controller are mounted in the inner portion of the stator of the motor. However, the assembly of the system remains complex. as it is obtained by fitting several pieces together and the elements are maintained in the stator using a rigid maintenance structure. Furthermore, the transmission system is not secured because the rotating rotor is capable of producing filings, which can cause short circuits.

Document WO-A-03/097437 describes a drive system comprising a motor, accumulators, and a controller mounted in a single assembly. The accumulators and the controller are mounted in the inner part of the stator of the motor. However, the system remains complex, as it is obtained by fitting several pieces together. Furthermore, the transmission system is not secured, as the rotating rotor is capable of producing filings, which can cause short circuits.

Document U.S. Pat. No. 5,732,786 describes a wheel comprising a motor, accumulators, and a controller. However, the assembly remains complex, as the elements are not in the same assembly and are mounted on an internal support.

Document EP-A-1 350 652 describes a drive system comprising a motor, accumulators, and a controller in a single assembly. The accumulators and the controller are mounted in the inner portion of the stator of the motor. However, the assembly of the system remains complex, as it is obtained by fitting several pieces together and the elements are mounted on an internal support. Furthermore, the transmission system is not secured, as the rotating rotor is capable of producing filings, which can cause short circuits.

Document WO 98/19875 describes a drive system comprising a motor, accumulators, and a controller in a single assembly. However, the assembly of the system remains complex, as it is obtained by fitting several pieces together and the elements are mounted on an internal support.

There is therefore a need for electric drive system that is easy to manufacture, and has improved security characteristics.

To that end, the invention proposes a self-contained electric drive system in which the elements necessary to operate and manage an electric rotary machine are maintained directly by a casing, and which comprises a transmission system having no metal wear parts.

More particularly, the invention relates to a self-contained drive system for a vehicle wheel, including a casing;
accumulators, which store and release the energy needed for the self-contained operation of the system;
at least one electric motor capable of generating a rotational movement;
a controller which manages the control of the electric motor (4) and of the accumulators;
a rotational shaft for the self-contained drive system (1); characterized in that
the casing directly supports and stands together by pressure the accumulators, the electric motor(s), and the controller;
the system does not include any metal wear parts in (the) mechanical transmission(s) of the rotational movement.

According to one embodiment, the casing is made from electrically insulating material.

According to one embodiment, the casing is made from filled or reinforced plastic.

According to one embodiment, the casing is made from a material comprising ABS-PC (Acrylonitrile Butadiene Styrene/Polycarbonate).

According to one embodiment, the casing comprises a gas expulsion valve.

According to one embodiment, at least one of the accumulators is of the Ni-MH or Li-ion type.

According to one embodiment, the accumulators are of the sealed cylindrical type and of format C, D or a derivative.

According to one embodiment, the center of gravity of the system is situated at the center of the casing.

According to one embodiment, the connection between the shaft and the casing is ensured by two ball bearings.

According to one embodiment, the electric motor is of the permanent magnet brushless direct current type.

According to one embodiment, the shaft stands together with a vehicle chassis and the casing stands together with a vehicle wheel.

According to one embodiment, the self-contained drive system according to the invention also comprises a wireless remote electronic management tool.

According to one embodiment, the casing stands together with a vehicle chassis, and the shaft stands together with a vehicle wheel.

According to one embodiment, the self-contained drive system comprises an electric motor situated at the center of the casing, such that the shaft of the electric motor is the shaft of the self-contained drive system.

According to one embodiment, the self-contained drive system comprises an electric motor situated at a radial distance from the shaft of the self-contained drive system.

According to one embodiment, the mechanical transmission of the rotational movement is done by at least one plastic pinion and/or at least one belt not reinforced by metals.

The invention also relates to a vehicle comprising one or more self-contained drive systems.

Other features and advantages of the invention will appear upon reading the following detailed description. This description is provided solely as an example, and in reference to the appended figures, which show:

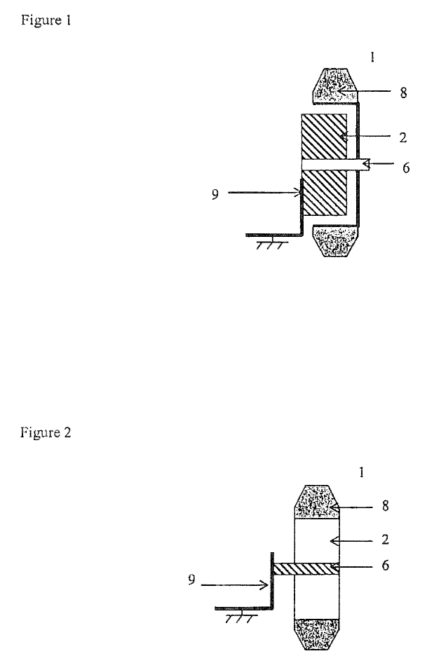

FIG. 1, a self-contained drive system according to a first embodiment;

FIG. 2, a self-contained drive system according to a second embodiment;

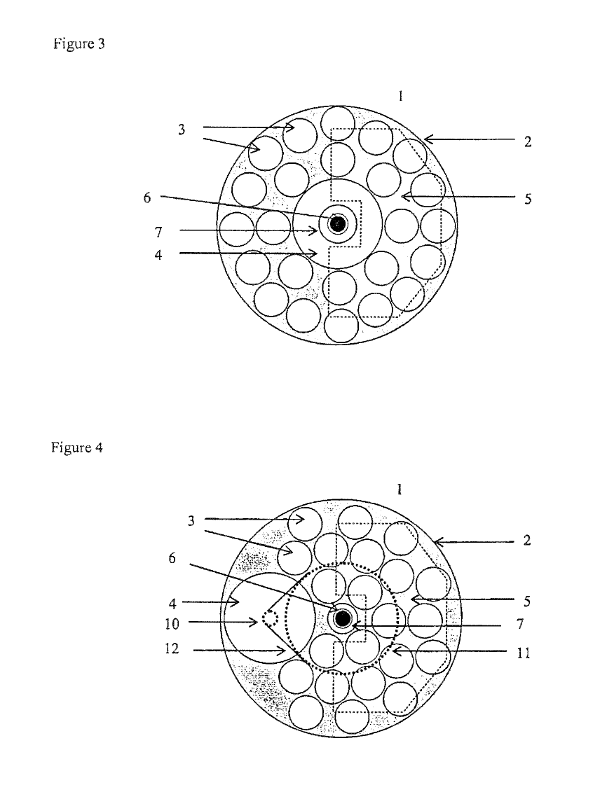

FIG. 3, a self-contained drive system showing an example of mechanical transmission in one of the embodiments of FIGS. 1 and 2, in which the output shaft of the motor is the rotational shaft of the self-contained drive system;

FIG. 4, a self-contained drive system showing an example of mechanical transmission in one of the embodiments of FIGS. 1 and 2, in which the output shaft of the motor is at a radial distance from the rotational shaft of the self-contained drive system.

The self-contained drive system according to the invention is adapted to be integrated into a vehicle wheel. The main advantage of the drive system according to the invention lies in the simplicity of its implementation. It comprises a casing that directly supports and stands together:
one or more electric motors that can generate a rotational movement,
rechargeable accumulators that store and release the energy needed for the self-contained operation of the system,
and a controller that manages the control of the electric motor and the accumulators.

The system also has safety advantages. In fact, the system does not comprise any metal wear parts in (the) mechanical transmission(s) responsible for transmission of the rotational movement. Thus, when the system is operating, it does not produce filings that can cause short circuits when they come into contact with the electrical parts.

The self-contained drive system will be better understood in reference to FIGS. 3 and 4, which each show a self-contained drive system according to the invention.

The casing 2 directly supports and stands together the accumulators 3, the electric motor 4, and the controller 5. For example, the casing 2 can comprise two profiled half-shells to receive the electric motor 4, the accumulators 3, and the controller 5. A first half-shell can be fastened to the rim of the wheel, and the second half-shell fits on the first half-shell. By adjusting through screws, the pressure exerted on the half-shells increases, allowing the casing 2 to directly support and maintain the elements. In this way, the system does not comprise any internal maintenance elements, and the structure of the self-contained drive system is simplified. According to another embodiment, the casing 2 may be made in a single piece. The casing 2 is for example overmolded around the accumulators 3, the electric motor 4, and the controller 5. All of the elements are thus directly supported by the casing 2 and stood together by pressure in the casing 2. No other fastening elements are necessary to maintain an element (such as screws or glue, for example).

Preferably, the elements are distributed so as to avoid a unbalance effect during setting in rotation. For example, the elements may he positioned around the shaft 6, so that the center of gravity of the system is located at the center of the casing 2.

Preferably, the casing 2 is made from an electrically insulating material, and also has mechanical properties that make it possible to ensure the maintenance of the elements and strength to withstand the mechanical strains undergone by the system, such as vibrations or impacts. For example, the material of the casing 2 can be ABS-PC (Acrylonitrile Butadiene Styrene/Polycarbonate) or a composite material. The material of the casing 2 can also be plastic containing filler (mineral particles, for example) or reinforced plastic (by glass fibers, for example).

Preferably, the casing 2 has protective features for the elements of the system, and security features for users. For example, the casing 2 may comprise a gas expulsion valve so as to discharge potentially flammable gases that may be produced by a malfunctioning accumulator. Typically, the gas expulsion valve may be a Gore-Tex membrane.

Preferably, the casing 2 is tight. For example, if the casing 2 comprises two half-shells, the latter may fit together hermetically. To improve the tightness of the inner portion of the casing 2, the connection between the shaft 6 and the casing 2 may be ensured by two ball bearings 7. Plastic seals may also be positioned between the pieces making up the casing 2.

The rechargeable accumulators 3 store and release the energy necessary for the self-contained operation of the system according to the invention. In order to ensure sufficient autonomy of the system to feed the electric motor 4, the accumulators 3 used may be of the Ni-MH or Li-ion type. Indeed, these accumulators 3 have the best volume energy performance. Preferably, the accumulators 3 are tight so as to support a rotational movement and the vibrations of the system. Typically, the accumulators 3 can be cylindrical and are not limited in terms of their formats. It is possible to use standard industrial formats, for example C, D, or derivative formats according to the ANSI (American National Standards Institute) standard. These formats can apply to accumulators of the Li-Ion and Ni-MH type. Preferably, the accumulators can be recharged without being taken out of the drive system. To that end, electrical connection terminals can make it possible to recharge the accumulators 3 using an outside charger.

The controller 5 manages the control of the electric motor 4 from the energy supplied by the accumulators 3. The controller 5 can for example comprise control functions with subjugation to the speed, or to the torque, of over-current and over-temperature safeties. The controller 5 can also comprise a transmitter that makes it possible to receive the control instructions from the electric motor 4, and to transmit information relative to the operation of the electric motor 4 to a remote device. The information relative to the electric motor 4 can be its speed, or other information making it possible to diagnose the electric motor 4. The controller 5 also comprises management functions for the accumulators 3. The controller 5 can for example comprise functions for managing the state of charge, voltage, temperature, current of the battery. The controller 5 can also comprise functions adapted to each type of accumulator 3. For example, if an accumulator 3 is of the Li-ion type, the controller 5 can comprise safety functions related to the use of the lithium, such as disconnection in the event of overload, over-discharge, over-current, or short-circuit in the accumulator.

The system can also comprise a remote electronic management tool adapted to communicate with the transmitter of the controller. The electronic management tool can for example be positioned on the guide member of the object on which the system is mounted.

The drive system according to the invention can be integrated into a wheel 8 of a vehicle.

In a first embodiment shown in FIG. 1, the casing 2 stands together with a chassis 9 of the vehicle and the shaft 6 stands together with the wheel 8. The wheel 8 can be rotated by the shaft 6 set in rotation by the electric motor 4, the casing 2 remaining stationary. In this embodiment, a fixed connection can be established with remote components. For example, a remote electronic management tool can be connected to the casing 2 through a fixed communication means. An electric connection can also make it possible to feed the system from an auxiliary source during operation, or can make it possible to connect several self-contained motors.

In a second embodiment shown in FIG. 2, the shaft 6 stands together with a chassis 9 of the vehicle and the casing 2 stands together with the wheel 8. The wheel 8 can be rotated by the casing 2 set in rotation by the electric motor 4. The accumulators 3 and the controller 5 are rotated with the casing 2, the shaft remaining stationary.

The drive system according to the invention is the same irrespective of how it is fastened to the wheel of the vehicle (casing fastened to the chassis or fastened to the wheel). The manufacture of the system is therefore simplified, the choice of assembly being made at the time of fastening to the vehicle.

The self-contained electric drive system 1 does not comprise any metal wear parts in the mechanical transmission responsible for transmission of the rotational movement. Thus, when the system is in operation, it does not produce filings that can cause short circuits when they come into contact with the electrical parts, in particular the battery or batteries and the controller. The self-contained electric system according to the invention thus has improved safety.

Preferably, the electric motor 4 is of the permanent magnet brushless DC motor (BLDC) type. This motor has the additional advantage of being silent during operation and having an improved lifetime.

In one embodiment shown in FIG. 3, the electric motor 4 is situated at the center of the casing 2, and the shaft of the electric motor 4 is the shaft 6 of the drive system 1. The electric motor 4 can then directly rotate a wheel 8 of the vehicle to which the self-contained drive system 1 is fastened.

In another embodiment illustrated in FIG. 4, a gear reduction effect between the electric motor 4 and the transmitted rotational movement is sought. The electric motor 4 is situated at a radial distance from the shaft 6 of the drive system 1, and sets a pulley 10 of the electric motor 4 in rotation. The system has a pulley 11 of the shaft 6 situated at the center of the casing 2. The pulley 10 of the electric motor 4 rotates the pulley 11 of the shaft 6 via one or several mechanical transmissions. Said mechanical transmissions can comprise a synchronous belt 12 not reinforced by metals, and/or plastic pinions. The synchronous belt 12 can for example be reinforced by glass fibers. In one embodiment, a belt 12 is used whereof the surface has notches that fit into the teeth of the toothed pulley 11. This makes it possible to transmit power from the electric motor 4 to a wheel 8, without risk of slipping of the belt 12 relative to the surface of the pulley, and allows good transmission of the torque of the electric motor 4.

In one particular embodiment, the shaft 6 stands together with the chassis 9 of the vehicle and the casing 2 stands together with the wheel 8. The electric motor 4 is situated at a radial distance from the shaft 6 of the drive system 1. The electric motor 4 generates a rotational movement of the pulley 11 of the shaft 6 via one or several mechanical transmissions as described in the preceding paragraph. The casing begins to rotate, rotating the wheel 8, the accumulators 3, the controller 5, and the electric motor 4, the shaft 6 remaining stationary. This particular embodiment corresponds to the combination of the embodiments shown in FIGS. 2 and 4.

However, the two embodiments for fastening the self-contained system can be combined with any one of the two transmission modes for transmitting the rotational movement presented above.

The self-contained drive system can be installed in many objects, for example a vehicle. In particular, the self-contained drive system according to the invention can be used to drive the wheels of a light car. The motor can then have a maximum power in the vicinity of a kilowatt.

Of course, the present invention is not limited to the embodiments described as examples.

1. A self-contained drive system for a vehicle wheel, including:
a casing (2);
accumulators (3), which store and release the energy needed for the self-contained operation of the system;
at least one electric motor (4) capable of generating a rotational movement;
a controller (5) which manages the control of the electric motor (4) and of the accumulators (3);
a rotational shaft (6) for the self-contained drive system (1); characterized in that
the casing (2) directly supports and stands together by pressure the accumulators (3), the electric motor(s) (4), and the controller (5);
the system does not include any metal wear parts in (the) mechanical transmission(s) of the rotational movement.

2. The self-contained drive system (1) according to claim 1, wherein the casing (2) is made from electrically insulating material.

3. The self-contained drive system (1) according to claim 1, wherein the casing (2) is made from filled or reinforced plastic.

4. The self-contained drive system (1) according to claim 3, wherein the casing (2) is made from a material comprising ABS-PC (Acrylonitrile Butadiene Styrene/Polycarbonate).

5. The self-contained drive system (1) according to claim 1, wherein the casing (2) comprises a gas expulsion valve.

6. The self-contained drive system (1) according to claim 1, wherein at least one of the accumulators (3) is of the Ni-MH or Li-ion type.

7. The self-contained drive system (1) according to claim 1, wherein the accumulators (3) are of the sealed cylindrical type and of format C, D or a derivative.

8. The self-contained drive system (1) according to claim 1, wherein the center of gravity of the system is situated at the center of the casing (2).

9. The self-contained drive system (1) according to claim 1, wherein the connection between the shaft (6) and the casing (2) is ensured by two ball bearings (7).

10. The self-contained drive system (1) according to claim 1, wherein the electric motor (4) is of the permanent magnet brushless direct current type.

11. The self-contained drive system (1) according to claim 1, also comprising a wireless remote electronic management tool.

12. The self-contained drive system (1) according to claim 1, wherein the shaft (6) stands together with a vehicle chassis (9) and the casing (2) stands together with a vehicle wheel (8).

13. The self-contained drive system (1) according to claim 1, wherein the casing (2) stands together with a vehicle chassis (9), and the shaft (6) stands together with a vehicle wheel (8).

14. The self-contained drive system (1) according to claim 1, comprising an electric motor (4) situated at the center of the casing (2), such that the shaft of the electric motor (4) is the shaft (6) of the self-contained drive system (1).

15. The self-contained drive system (1) according to claim 1, comprising an electric motor (4) situated at a radial distance from the shaft (6) of the self-contained drive system (1).

16. The self-contained drive system (1) according to claim 15, wherein the mechanical transmission of the rotational movement is done by at least one plastic pinion and/or at least one belt not reinforced by metals.

17. A vehicle comprising one or more self-contained drive systems (1) according to claim 1.
